(19) United States
(12) Patent Application Publication
(10) Pub. No.: US 2022/0016948 A1
(43) Pub. Date: Jan. 20, 2022

(54) COUPLING DEVICE, AGRICULTURAL VEHICLE AND METHOD FOR MECHANICAL COUPLING AND MEDIA SUPPLY BETWEEN A CARRIER VEHICLE AND A SUPERSTRUCTURE

(71) Applicant: AVL Commercial Driveline & Tractor Engineering GmbH, Steyr (AT)

(72) Inventors: Thomas WOOPEN, Windeck (DE); Stephan HAMMES, Dusseldorf (DE); Frank Michael MÜLLER, Wegberg (DE)

(73) Assignee: AVL Commercial Driveline & Tractor Engineering GmbH, Steyr (AT)

(21) Appl. No.: 17/295,525

(22) PCT Filed: Nov. 20, 2019
(86) PCT No.: PCT/AT2019/060393

§ 371 Date: May 20, 2021

(30) Foreign Application Priority Data
Nov. 20, 2018 (DE) 10 2018 129 181.7

(51) Int. Cl. B60D 1/64; A01B 59/06; A01B 59/04

(52) U.S. Cl. CPC B60D 1/64; B60D 2001/008; A01B 59/04; A01B 59/06

(57) ABSTRACT

The present invention relates to a coupling device (1) for mechanical coupling and media supply between a carrier vehicle (41) and a superstructure (42), having a coupling mechanism (10) for establishing a mechanical coupling between the carrier vehicle (41) and the superstructure (42) and a media mechanism (20) for establishing a media supply between the carrier vehicle (41) and the superstructure (42), which are operatively connected with each another via an operating mechanism (30). The coupling mechanism (10) is mounted so as to be moveable between at least one first coupling position at least partially forming the mechanical coupling and a release position releasing the mechanical coupling. The media mechanism (20) is also mounted so as to be moveable between a supply position forming the media supply and a shut-off position shutting off the media supply. The operating mechanism (30) has at least one guide means (31) for a forced guidance of the media mechanism (20) from the shut-off position into the supply position on a movement of the coupling mechanism (10) from the release position into the first coupling position. The invention also relates to an agricultural working vehicle (40) and a method for mechanical coupling and media supply between a carrier vehicle (41) and a superstructure (42).

The present invention relates to a coupling device as well as an agricultural working vehicle and a method for mechanical coupling and media supply between a carrier vehicle and a superstructure.

Coupling devices, so-called twist locks, for coupling or connecting containers or superstructures on carrier vehicles or other superstructures are for example known from DE 38 22 034 A1. Such coupling devices enable a mechanical coupling between the superstructure and the carrier vehicle. Locking heads with locking bolts which can be rotated into a locking position can thereby be provided.

In particular, in the case of agricultural working vehicles with a carrier vehicle and a superstructure it can be necessary to transfer electrical power from the carrier vehicle to the superstructure or to provide an electrical power coupling. In known mechanical couplings between the carrier vehicle and the superstructure, there is no power interface for establishing an electrical power supply. Thus, a separate power coupling between the carrier vehicle and the superstructure must be provided, which requires a separate construction space or a separate connection and gives rise to costs in addition to the mechanical coupling.

It is the object of the present invention to remedy, at least partially, the disadvantages described above. In particular, it is the object of the present invention to provide a coupling device with an improved and efficient mechanical coupling and a simultaneous power supply. It is also the object of this invention to provide an agricultural working vehicle as well as a method for mechanical coupling and power supply between a carrier vehicle and a superstructure.

The above object is achieved by a coupling device with the features of claim 1, as well as by an agricultural working vehicle with the features of claim 10 and a method with the features of claim 11. Further features and details of the invention are disclosed in the dependent claims, the description and the drawings. Naturally, features and details which are described in connection with the coupling device according to the invention also apply in connection with the agricultural working vehicle according to the invention and the method according to the invention and vice versa, so that with regard to disclosure mutual reference is, or can, always be made to the individual aspects of invention.

According to a first aspect of the present invention, a coupling device for mechanical coupling and media supply between a carrier vehicle and a superstructure is provided, having a coupling mechanism for establishing a mechanical coupling between the carrier vehicle and the superstructure and a media mechanism for establishing a media supply between the carrier vehicle and the superstructure which are operatively connected with each other via an operating mechanism. The coupling mechanism is mounted so as to be moveable between at least one first coupling position at least partially forming the mechanical coupling and a release position releasing the mechanical coupling. Furthermore, the media mechanism is mounted so as to be moveable between a supply position forming the media supply and a shut-off position shutting off the media supply. The operating mechanism has at least one guide means for a forced guidance of the media mechanism from the shut-off position into the supply position on a movement of the coupling mechanism from the release position into the first coupling position.

Within the context of the application, the coupling mechanism can be designed in the form of a mechanical coupler, for example as a twist lock. The coupling mechanism can for example be designed in the form of a locking mechanism with a locking bolt and an associated locking head. Mechanical coupling refers for example to a force- and/or form-locking connection between the carrier vehicle and the superstructure which can be provided by the coupling mechanism. In general, any type of mechanical coupling can be used for the coupling mechanism.

The release position comprises a state of the carrier vehicle and superstructure in which the mechanical coupling is released. In other words, in the release position the carrier vehicle and the superstructure are moveable relative to each other. In the release position, the carrier vehicle and the superstructure are not mechanically coupled or fixed relative to each other. For example, in the release position the coupling mechanism can be connected with the carrier vehicle and arranged in an uncoupled state in a housing within the superstructure.

The first coupling position comprises a state of the carrier vehicle and superstructure in which the mechanical coupling is at least partially formed. In other words, in the first coupling position the carrier vehicle and the superstructure are already mechanically fixed to each other, but are not yet fixed with the maximum applicable force. In the first coupling position, the coupling mechanism can for example be arranged at least partially locked in the housing of the superstructure, as a result of which a mechanical coupling between the carrier vehicle and the superstructure is already established. In the complete coupling position, the coupling mechanism is preferably arranged completely locked in the housing of the superstructure. In the complete coupling position, no relative movement between the carrier vehicle and the superstructure is possible and the carrier vehicle and the superstructure are substantially fixed to each other with the maximum applicable force.

Within the context of the application, the medium comprises an electrical, a hydraulic and/or a pneumatic medium. The media supply or the power supply can therefore be provided electrically and/or hydraulically and/or pneumatically. The media mechanism can for example be designed in the form of a power coupler or multicoupler for providing the media supply. Advantageously, both an electrical power supply as well as a hydraulic power supply is provided by means of the media supply.

The supply position comprises a state of the carrier vehicle and the superstructure in which the media supply is formed. In other words, in the supply position a transfer of the medium or a power supply between the carrier vehicle and the superstructure takes place.

The shut-off position comprises a state of the carrier vehicle and the superstructure in which the media supply is shut off. In other words, in the shut-off position no transfer of the medium or power supply between the carrier vehicle and the superstructure takes place.

The invention has the advantage that the coupling mechanism and the media mechanism are operatively connected with each other via an operating mechanism. Within the context of the application, operative connection refers to a transmission of a movement and/or a force or an initiation of a function. For example, a shift from the shut-off position into the supply position and at the same time a shift from the release position into the coupling position and vice versa can be effected by means of the operating mechanism. A combined mechanical coupling and a media supply can therefore be provided within a single coupling device. According to the invention, a coupling device is therefore provided which on the one hand makes it possible to mechanically connect a superstructure to a carrier vehicle and on the other hand makes possible an electrical and hydraulic power supply between the superstructure and the carrier vehicle. Consequently, a separate power supply in a separate component or a separate connection can be dispensed with and therefore construction space can be saved.

The coupling device according to the invention can be used advantageously in agricultural working vehicles. For example, the coupling device according to the invention is suitable for carrier vehicles such as tractors and superstructures, for example self-propelled or passive trailers, suspended attachments or spreader boxes. The coupling device according to the invention is generally suitable for carrier vehicles with a superstructure (vehicle implement) where both a mechanical coupling and a power supply, in particular electrical and hydraulic, is required.

In a preferred embodiment, the operating mechanism has a delay section for delaying the start of the movement of the media mechanism from the shut-off position into the supply position until the first coupling position of the coupling mechanism has been reached. In other words, the movement of the media mechanism into the supply position is delayed for a period of time until the carrier vehicle and superstructure are mechanically fixed in the first coupling position. Thus, an initial mechanical fixing or pre-fixing in the first coupling position can take place. Immediately after the initial fixing, or immediately after the first coupling position has been reached, the initiation of the media supply and at the same time the further shifting of the coupling mechanism from the first coupling position into a complete coupling position can take place. This has the advantage that in the first coupling position a precise and correct positioning between the carrier vehicle and the superstructure can be achieved due to the initial fixing, as a result of which a secure and correct shifting of the media mechanism into the supply position can be guaranteed. In other words, the media supply, in particular the power supply connection, is established immediately after a mechanical coupling in the first coupling position has taken place. In this way, undesirable relative movements between the carrier vehicle and the superstructure which could hinder a correct shifting of the media mechanism into the supply position can be avoided.

Preferably, the carrier vehicle and the superstructure are simultaneously in the supply position and in the complete coupling position.

In a further embodiment it is conceivable that the delay section has a guide geometry with a guide curve, wherein a guide element of the media mechanism is mounted moveably within the guide curve, wherein a straight-line movement of the guide element is provided for the delay and a height adjustment of the guide element is provided for the movement of the media mechanism into the supply position. The delay section or the guide geometry can for example be designed in the form of a flat plate, wherein the guide curve is arranged within the plate in the form of an, in particular, continuous recess or groove. The guide element of the media mechanism can for example be designed in the form of a guide rod or guide roller which is mounted so as to be moveable within the guide curve or the recess. Due to the movement of the guide element, the media mechanism can be guided into its position. In particular, the media mechanism can be height-adjusted along the guide curve via the movement of the guide means. The media mechanism can preferably be shifted from the shut-off position into the supply position and vice versa by means of the height adjustment. The guide curve has for example a horizontal guide section for the delay. The media mechanism is therefore moved on a horizontal plane for a period of time before a height adjustment of the media mechanism takes place. The height adjustment of the media mechanism can advantageously be carried out automatically by at least one actuator. A lifting movement of the media mechanism or the height adjustment can be realised by means of the actuator. In particular, the use of the guide curve has the advantage that a precise and exactly-timed shift of the media mechanism into the supply position or the shut-off position can take place.

Preferably, it can be the case that the operating mechanism has at least one actuator, in particular a linear actuator, for an automated movement of the media mechanism and/or the coupling mechanism. The actuator can preferably be designed in the form of a motor drive. Furthermore, the actuator has a force-transmitting or operative connection with the media mechanism and/or the coupling mechanism. Alternatively, the operating mechanism can also be operated manually.

It is also conceivable that the guide means has a gear mechanism for converting a transverse movement of the guide means into a rotary movement of the coupling mechanism. The guide means of the operating mechanism is for example designed in the form of an actuating linkage which is mounted so as to be moveable, in particular in a transverse direction. The actuating linkage can in particular be moved automatically or manually. For example, a locking of the coupling mechanism can be effected via the converted rotary movement of the coupling mechanism by means of a locking mechanism. In other words, a rotary movement of the coupling mechanism to shift into the first or complete coupling position can be effected, via the gear mechanism, through a transverse movement of the actuating linkage. Similarly, the transverse movement can also be reversed in order to unlock the coupling mechanism or to shift into the release position.

In a particularly preferred embodiment it is conceivable that the media mechanism has several plug contacts, in particular arranged in pairs, wherein at least one plug contact for a hydraulic coupling and at least one plug contact for an electrical coupling, in particular a high-voltage coupling, are arranged on the media mechanism and the plug contacts can in each case make contact with an associated mating plug contact of the carrier vehicle and/or the superstructure in the supply position. The media mechanism is preferably designed for the transmission of hydraulic, electrical or pneumatic power. In particular, the electrical transmission can take place in the high-voltage range (more than 60 volts) and/or in the low-voltage range. The media mechanism forms a kind of interface with a mating interface of the carrier vehicle and/or the superstructure. In order to assume the supply position, the media mechanism is guided along the guide curve, for example on the superstructure, by means of the guide element or the guide roller. In the supply position, the plug contacts of the media mechanism are in power-transmitting contact with the mating plug contacts of the superstructure. Due to the plug contacts in the high-voltage range, a higher electrical power can also be transmitted in addition to the usual power supply. Both the plug contacts in the high-voltage range and the plug contacts for the hydraulic media supply can be provided in any number, in particular in pairs. For example, a plug contact in the low-voltage range can be provided which serves to provide both the low-voltage supply of the superstructure as well as the BUS communication between the carrier vehicle and the superstructure.

Preferably, the operating mechanism has at least one cover for the media mechanism which is arranged at a distance from the media mechanism and covers the plug contacts opposite the carrier vehicle and/or the superstructure, and is coupled with the operating mechanism and mounted moveably via a lever mechanism. Preferably, the media mechanism, in particular the plug contacts of the media mechanism, is substantially completely covered by the cover in the shut-off position. Therefore, in the shut-off position the plug contacts are protected by means of the cover. The cover is preferably removed from the media mechanism, in particular automatically, during the shift from the shut-off position into the supply position, so that the media mechanism can be shifted into the supply position. The cover is removed via the movement of the lever mechanism, which is coupled with the moveable operating mechanism. Thus, the cover can be moved or displaced relative to the media mechanism via the actuation or movement of the operating mechanism, in particular the actuating linkage.

Furthermore, it can be preferably be the case that the lever mechanism has a gear mechanism as a result of which the media mechanism is substantially completely covered by the cover in the shut-off position and the media mechanism is uncovered in the supply position. The gear mechanism of the lever mechanism is preferably designed in such a way that the cover is substantially removed completely from the media mechanism when the coupling mechanism is moved into the first coupling position. This ensures that the superstructure can no longer be detached from the carrier vehicle with a small application of force, while the media supply is carried out by means of the media mechanism.

In a further embodiment it is conceivable that the media mechanism has a further guide element for tilt-free movement of the media mechanism. For example, the further guide element can be designed in the form of a further guide roller or as a recess within the media mechanism in which a corresponding mating element of the operating mechanism can engage to ensure tilt-free mounting. In particular, a horizontal alignment of the media mechanism can be ensured. A tilted position can therefore be avoided when the plug contacts make contact with the mating plug contacts in the supply position.

According to a second aspect of the invention, an agricultural working vehicle comprising a carrier vehicle, a superstructure and a coupling device for mechanical coupling and media supply between the carrier vehicle and the superstructure is provided. The coupling device is thereby designed according to one of the aforementioned embodiments. The agricultural working vehicle according to the invention thereby brings with it the same advantages as have been described in detail with reference to the coupling device according to the invention.

According to a third aspect of invention, a method for mechanical coupling and media supply between a carrier vehicle and a superstructure by means of a coupling device which is in particular designed according to one of the aforementioned embodiments is provided. The coupling device has a coupling mechanism for establishing a mechanical coupling between the carrier vehicle and the superstructure and a media mechanism for establishing a media supply between the carrier vehicle and the superstructure which are operatively connected to each other via an operating mechanism. The coupling mechanism is mounted so as to be moveable between at least one first coupling position at least partially forming the mechanical coupling and a release position releasing the mechanical coupling. Furthermore, the media mechanism is mounted so as to be moveable between a supply position forming the media supply and a shut-off position shutting off the media supply. A forced guidance of the media mechanism from the shut-off position into the supply position is initiated on a movement of the coupling mechanism from the release position into the first coupling position.

The starting position is for example considered as being the state in which the carrier vehicle and the superstructure are positioned correctly in relation to each other, but are not yet mechanically coupled. The coupling mechanism of the carrier vehicle is advantageously arranged in a housing of the superstructure. The media mechanism is at this time mounted within the interior of the vehicle, for example, protected by means of the cover.

The movement of the coupling mechanism from the release position into the first coupling position is preferably effected by a transverse movement of the actuating linkage of the operating mechanism. The transverse movement is converted by means of a gear mechanism into a rotary movement to lock the coupling mechanism. The movement of the operating mechanism, in particular the actuating linkage, can thereby be effected manually or automatically, for example via linear actuators. The coupling mechanism is moved into the first coupling position. When the first coupling position is reached, the forced guidance of the media mechanism into the supply position is advantageously initiated. This has the advantage that in the first coupling position a precise and correct positioning between the carrier vehicle and the superstructure can be achieved due to the initial fixing, whereby a secure and correct shifting of the media mechanism into the supply position can be guaranteed. In other words, the media supply, in particular the power supply connection, is established immediately after a mechanical coupling in the first coupling position has taken place. In this way, undesirable relative movements between the carrier vehicle and the superstructure which could hinder a correct shifting of the media mechanism into the supply position can be avoided

In a particularly preferred embodiment, the start of the movement of the media mechanism from the shut-off position into the supply position is delayed until the first coupling position of the coupling mechanism has been reached. For this purpose, the operating mechanism has a guide geometry which effects a height adjustment of the media mechanism via a guide curve and a guide element of the media mechanism that is mounted moveably within the guide geometry. The media mechanism is preferably not yet height-adjusted as the coupling mechanism shifts into the first coupling position. For this purpose, in a delay section, the guide geometry initially runs in a substantially straight line or horizontally, for example, so that the media mechanism does not collide with the cover.

While the actuating linkage continues to be moved transversely after the first coupling position, the coupling mechanism is locked further and shifted into the complete coupling position. Meanwhile, advantageously, due to the guide geometry, a first, in particular transverse, lifting motion or height adjustment of the media mechanism takes place. The media mechanism is brought up to the superstructure or shifted into the supply position.

The lever mechanism of the cover can thereby preferably be deactivated, so that the cover no longer moves as soon as the position of the media mechanism is changed.

When the actuating linkage is pulled to its final position or the complete coupling position, the coupling mechanism is preferably completely locked, so that relative movements between superstructure and carrier vehicle are no longer possible. The media mechanism is moved completely into the supply position at this time, so that the plug contacts of the media mechanism are connected with the mating plug contacts of the superstructure. This allows electrical and hydraulic power to be transmitted from the carrier vehicle to the superstructure.

Preferably, a cover is removed from the media mechanism when the first coupling position of the coupling mechanism is reached. The cover is advantageously removed via the lever mechanism, which is coupled with the operating mechanism. The gearing of the lever mechanism is in particular thereby designed in such a way that the cover is substantially pushed completely to the side when the coupling mechanism reaches the first coupling position. This ensures that the superstructure can no longer be detached with a small application of force while the power supply coupling operation is carried out.

In a further preferred embodiment, the forced guidance of the media mechanism from the shut-off position into the supply position and the movement of the coupling mechanism from the release position into the first or the complete coupling position is performed reversibly, whereby the mechanism media is shifted into the shut-off position and the coupling mechanism into the release position. Thus, when decoupling the carrier vehicle and the superstructure, the same operation can be carried out in reverse. In other words, the media mechanism is shifted substantially completely into the shut-off position when the coupling mechanism reaches the first coupling position. As the coupling mechanism is shifted from the first coupling position into the release position, the cover is preferably displaced via the media mechanism.

The method according to the invention thus brings with it the same advantages as have been described in detail with reference to the device according to the invention.

The invention is explained in more detail below on the basis of non-limiting exemplary embodiments which are shown in the figures, wherein

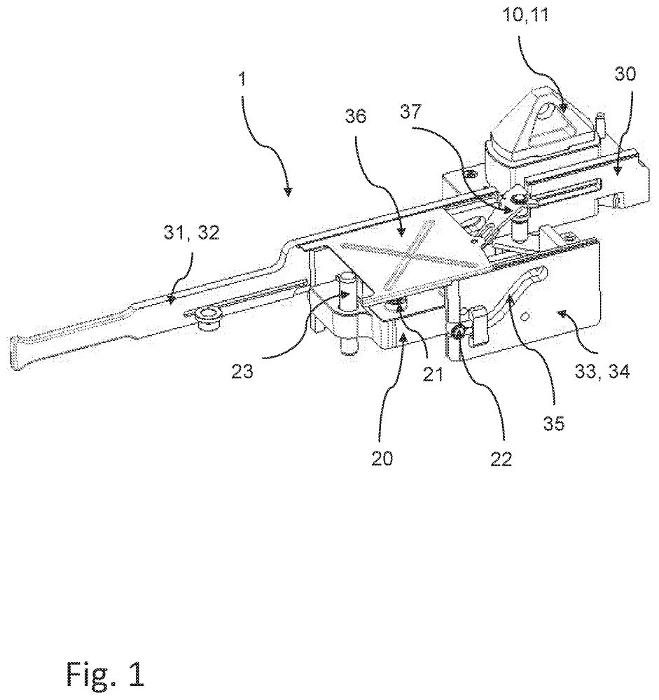

FIG. 1 shows a perspective view of a coupling device according to the invention according to a first exemplary embodiment;

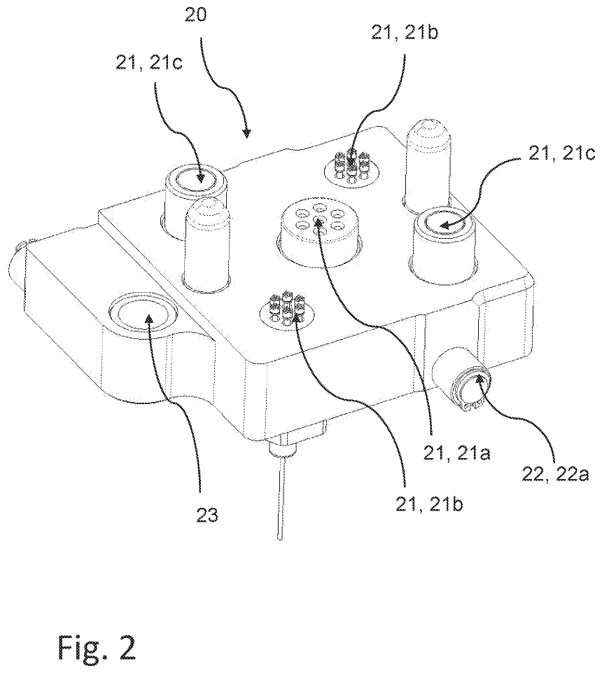

FIG. 2 shows a perspective view of a media mechanism of a coupling device according to the invention according to a further exemplary embodiment;

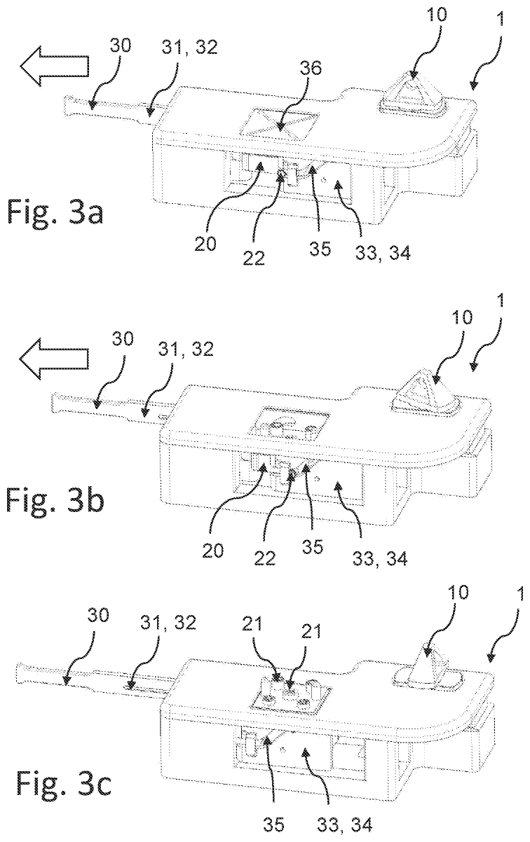

FIG. 3a-c shows three perspective views of a coupling device according to the invention in a method according to the invention according to a third exemplary embodiment;

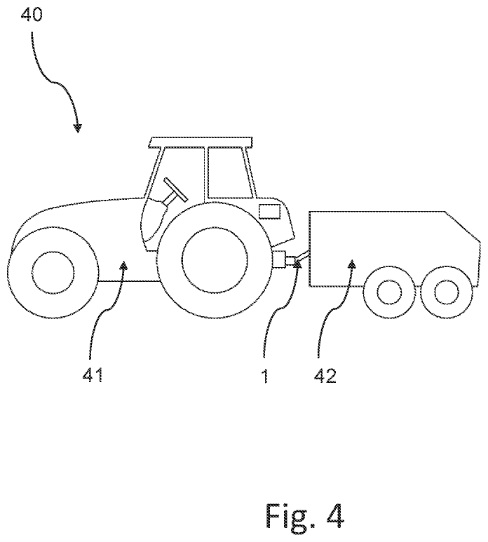

FIG. 4 shows a schematic side view of an agricultural working vehicle according to the invention with a coupling device according to the invention.

In the following figures, for the sake of clarity, similar elements are identified with the same reference signs.

A perspective view of a coupling device 1 according to the invention according to a first exemplary embodiment is shown schematically in FIG. 1. The coupling device 1 is intended for mechanical coupling and media supply between a carrier vehicle (not shown) and a superstructure (not shown).

The coupling device 1 has a coupling mechanism 10 for establishing a mechanical coupling between the carrier vehicle and the superstructure. The coupling mechanism 10 is by way of example designed in the form of a twist lock 11 with a locking head and an associated locking mechanism. The twist lock 11 is mounted rotatably for locking or unlocking. In particular, a form-locking connection between the carrier vehicle and the superstructure is realised or released by twisting or rotating the twist lock 11.

The coupling mechanism 10, in particular the twist lock 11, is mounted so as to be moveable between at least one first coupling position at least partially forming the mechanical coupling and a release position releasing the mechanical coupling. The coupling mechanism 10 is shown by way of example in the release position. In the release position, the twist lock 11 is not locked and the carrier vehicle and the superstructure are moveable relative to each other. The coupling mechanism 10 or the twist lock 11 is connected to the carrier vehicle and arranged without coupling in a housing of the superstructure.

The coupling device 1 also has a media mechanism 20 for establishing a media supply between the carrier vehicle and the superstructure. The media mechanism 20 is mounted so as to be moveable between a supply position forming the media supply and a shut-off position shutting off the media supply. The media mechanism 20 has several plug contacts 21, in particular arranged in pairs, wherein at least one plug contact 21 for a hydraulic coupling and at least one plug contact 21 for an electrical coupling, in particular a high-voltage coupling, are arranged on the media mechanism 20 and the plug contacts 21 can in each case make contact with an associated mating plug contact of the superstructure in the supply position. The media mechanism 20 is preferably designed for the transmission of hydraulic, electrical or pneumatic power.

The coupling mechanism 10 and the media mechanism 20 are operatively connected to each other via an operating mechanism 30. The operating mechanism 30 has at least one guide means 31. The guide means 31 is designed in the form of an actuating linkage 32. The coupling mechanism 10 and the media mechanism 20 are mounted so as to be moveable via the operating mechanism 30. For this purpose, the actuating linkage 32 is moved manually or automatically. A forced guidance of the media mechanism 20 from the shut-off position into the supply position can be carried out by means of the actuating linkage 32 on a movement of the coupling mechanism 10 from the release position into the first coupling position.

In order to move the coupling mechanism 10 from the release position into the first coupling position, the actuating linkage 32 of the operating mechanism 30 is moved transversely. For this purpose, the actuating linkage 32 has a gear mechanism for converting the transverse movement into a rotary movement of the coupling mechanism 10 or the twist lock 11. In particular, the actuating linkage 32 can be moved automatically or manually. A locking of the twist lock 11 can be effected via the converted rotary movement of the coupling mechanism 10. In other words, a rotary movement of the coupling mechanism 10 to shift into the first or into the complete coupling position can be effected, via the gear mechanism, through the transverse movement of the actuating linkage 32.

For the forced guidance of the media mechanism 20 from the shut-off position into the supply position, the operating mechanism 30 has a guide geometry 34 with a guide curve 35. The guide geometry 34 with the guide curve 35 forms a delay section 33 of the operating mechanism 30. The delay section 33 or the guide geometry 34 is designed in the form of a flat plate, wherein the guide curve 35 is arranged as a continuous recess or groove within the plate. The delay section 33 causes a delay in the start of the movement of the media mechanism 20 from the shut-off position into the supply position until the first coupling position of the coupling mechanism has been reached. In other words, the movement of the media mechanism 20 into the supply position is delayed for a period of time until the carrier vehicle and superstructure are fixed mechanically in the first coupling position.

For this purpose, a guide element 22 of the media mechanism 20 is mounted moveably within the guide curve 35. The guide element 22 of the media mechanism 20 is designed in the form of a guide roller which is mounted moveably in the guide curve 35 or the recess. As a result of the movement of the guide element 22, the media mechanism 20 can be carried along.

A straight-line movement of the guide element 22 is provided for the delay of the movement of the media mechanism 20 into the supply position and a height adjustment of the guide element 22 along the guide curve 35 is provided for the movement of the media mechanism 20 into the supply position. In other words, the guide curve 35 has a horizontal guide section. The media mechanism 20 is therefore first moved for a period of time on a horizontal plane before a height adjustment of the media mechanism 20 along the guide curve 35 takes place. In particular, the use of the guide curve 35 has the advantage that a precise and exactly-timed shift of the media mechanism 20 into the supply position or the shut-off position can take place.

The operating mechanism 30 also has a cover 36 for the media mechanism 20 which is arranged at a distance from the media mechanism 20 and covers the plug contacts 21 opposite the carrier vehicle and/or the superstructure. The cover 36 is coupled with the operating mechanism 30 and mounted moveably via a lever mechanism 37. The plug contacts 21 of the media mechanism are, for example, completely covered by the cover 36 and therefore protected. The cover 36 is preferably removed from the media mechanism 20, in particular automatically, during the shift into the first coupling position. As a result of the actuation or movement of the operating mechanism 30, in particular of the actuating linkage 32, the cover 36 can be moved or displaced relative to the media mechanism 20 via the lever mechanism 37.

The media mechanism 20 has a further guide element 23 for tilt-free movement of the media mechanism 20. The further guide element 23 is designed as a recess within the media mechanism 20 in which a corresponding mating element of the operating mechanism 30 can engage to ensure tilt-free mounting. In particular, a horizontal alignment of the media mechanism 20 can be ensured.

Overall, by means of the coupling device 1 a combined mechanical coupling and a media supply can be provided within a single device. Therefore, according to the invention, a coupling device 1 is provided which on the one hand makes it possible to connect a superstructure mechanically to a carrier vehicle and on the other hand makes possible a simultaneous electrical and hydraulic power supply between the superstructure and the carrier vehicle.

FIG. 2 shows a perspective view of a media mechanism 20 of a coupling device 1 according to the invention according to a further exemplary embodiment. The media mechanism 20 can for example also be arranged in the coupling device 1 as shown in FIG. 1. The media mechanism 20 forms a kind of interface to the power supply of the superstructure.

The media mechanism 20 has several plug contacts 21 which can in each case make contact with an associated mating plug contact of the superstructure in the supply position. The media mechanism 20 is plate-like in form, wherein the plug contacts 21 are in each case arranged in an associated recess and protrude in order to make contact. A plug contact 21 is designed as low-voltage contact 21a and is arranged centrally on the media mechanism 20. The low-voltage contact 21a can serve to provide both the low-voltage supply of the superstructure as well as the BUS communication between the carrier vehicle and the superstructure.

Two hydraulic contacts 21c and two high-voltage contacts 21b are arranged around the low-voltage contact 21a on opposite sides. The high-voltage contacts 21b make possible a transmission of power in the high-voltage range (more than 60 volts), as a result of which, in addition to the usual power supply in the low-voltage range, a higher electrical power can also be transmitted. The media mechanism 20 is, accordingly, designed for the transmission of hydraulic and electrical power.

In order to assume the supply position, the media mechanism is guided along the guide curve 35 of the guide geometry 34, for example on the superstructure, by means of the guide element 22 or the guide roller 22a. In the supply position, the plug contacts 21 of the media mechanism 20 are in power-transmitting contact with the mating plug contacts of the superstructure. Both the plug contacts 21b in the high-voltage range and the plug contacts 21c for the hydraulic media supply can be provided in any number, especially in pairs.

The media mechanism 20 has a further guide element 23 for tilt-free mounting of the media mechanism 20. The further guide element 23 is designed in the form of a recess in which an associated mating element of the operating mechanism 30 can engage.

FIGS. 3a-c show three perspective views of a coupling device 1 according to the invention in a method according to the invention according to a third exemplary embodiment. The coupling device 1 is designed as shown in FIG. 1.

In FIG. 3a, the coupling device 1 is shown in the release position or the shut-off position. In FIG. 3b, the coupling device 1 is shifted into the first coupling position, whereby a forced guidance of the media mechanism into the supply position is initiated. In FIG. 3c, the coupling device 1 is shown in the complete coupling position as well as in the supply position. The shifting into the individual positions is explained in detail below.

In FIG. 3a, the starting position is by way of example considered as being the state in which the carrier vehicle and the superstructure are positioned correctly in relation to each other, but are not yet mechanically coupled. The coupling device 1 or the carrier vehicle (not shown) and the superstructure (not shown) are shown in the release position. The coupling mechanism 10 is connected to the carrier vehicle and is arranged in a housing of the superstructure. The media mechanism 20 is at this time stored in the interior of the vehicle, protected by means of the cover 36. The guide element 22 of the media mechanism 20 is arranged at the beginning of the guide curve 35 of the guide geometry 34.

The movement of the coupling mechanism 10 from the release position into the first coupling position according to FIG. 3b is effected by a transverse movement of the actuating linkage 32 of the operating mechanism 30. The transverse movement of the actuating linkage 32 takes place in the direction indicated by the arrow.

The transverse movement is thereby converted by means of a gear mechanism into a rotary movement to lock the coupling mechanism 10. The movement of the actuating linkage 32 can thereby be effected manually or automatically, for example via linear actuators. The coupling mechanism 10 is as a result moved into the first coupling position in FIG. 3b. The movement into the first coupling position corresponds, for example, to a clockwise rotation of the coupling mechanism 10. In the first coupling position, the coupling mechanism 10 is already pre-locked.

During the movement of the coupling mechanism 10 into the first coupling position, the start of the movement of the media mechanism 20 from the shut-off position into the supply position is delayed until the first coupling position of the coupling mechanism 10 is reached. While the coupling mechanism 10 is shifting into the first coupling position, the media mechanism 20 is moved along the horizontal section of the guide curve 35, but is not yet height-adjusted. The guide element 22 is moved in a straight line along the horizontal section of the guide curve 35, for example to the right, but is not height-adjusted along the guide curve 35. The cover 36 is also removed from the media mechanism 20.

When the first coupling position according to FIG. 3b is reached, the forced guidance of the media mechanism 20 into the supply position is initiated. In other words, the media supply, in particular the power supply connection, is established immediately after a mechanical coupling in the first coupling position has taken place. In this way, undesirable relative movements between the carrier vehicle and the superstructure which could hinder a correct shifting of the media mechanism into the supply position can be avoided.

While the actuating linkage 32 continues to be moved transversely in the direction indicated by the arrow after the first coupling position, the coupling mechanism 10 is locked further and shifted into the complete coupling position as shown in FIG. 3c. Meanwhile, advantageously, due to the guide curve 35 a first, in particular transverse, lifting movement or height adjustment of the media mechanism 20 takes place. The media mechanism 20 is brought up to the superstructure or shifted into the supply position in FIG. 3c.

When the actuating linkage 32 is pulled to its final position or the complete coupling position, the coupling mechanism 10 is preferably completely locked, so that relative movements between superstructure and carrier vehicle are no longer possible.

The media mechanism 20 is completely moved into the supply position at this time, so that the plug contacts 21 of the media mechanism 20 can be connected or make contact with the mating plug contacts of the superstructure. This allows electrical and hydraulic power to be transmitted from the carrier vehicle to the superstructure.

FIG. 4 shows a schematic side view of an agricultural working vehicle 40 according to the invention with a coupling device 1 according to the invention. The agricultural working vehicle 40 comprises a carrier vehicle 41 and a superstructure 42. The carrier vehicle 41 and the superstructure are connected with each other by means of the coupling device 1. The coupling device 1 is intended for mechanical coupling and media supply between the carrier vehicle 41 and the superstructure 42. The carrier vehicle 41 is by way of example in the form of a tractor. The superstructure 42 can by way of example be designed as a self-propelled or passive trailer, suspended attachment or spreader box. The coupling device 1 according to the invention is generally suitable for carrier vehicles 41 with a superstructure 42 where both a mechanical coupling and a power supply, in particular electrical and hydraulic, is required.

### LIST OF REFERENCE SIGNS

1 coupling device
10 coupling mechanism
11 twist lock
20 media mechanism
21 plug contact
21a low-voltage contact
21b high-voltage contact
21c hydraulic contact
22 guide element
22a guide roller
23 further guide element
30 operating mechanism
31 guide means
32 actuating linkage
33 delay section
34 guide geometry
35 guide curve
36 cover
37 lever mechanism
40 agricultural working vehicle
41 carrier vehicle
42 superstructure

1. Coupling device (1) for mechanical coupling and media supply between a carrier vehicle (41) and a superstructure (42), having a coupling mechanism (10) for establishing a mechanical coupling between the carrier vehicle (41) and the superstructure (42) and a media mechanism (20) for establishing a media supply between the carrier vehicle (41) and the superstructure (42) which are operatively connected with each another via an operating mechanism (30), wherein the coupling mechanism (10) is mounted so as to be moveable between at least one first coupling position at least partially forming the mechanical coupling and a release position releasing the mechanical coupling, wherein the media mechanism (20) is also mounted so as to be moveable between a supply position forming the media supply and a shut-off position shutting off the media supply,
wherein
the operating mechanism (30) has at least one guide means (31) for a forced guidance of the media mechanism (20) from the shut-off position into the supply position on a movement of the coupling mechanism (10) from the release position into the first coupling position,
characterised in that
in addition to the first coupling position the coupling mechanism (10) has a complete coupling position (Off: 5/6-10; 10/17-19; 18/13-15; FIG. 3b+3c),
wherein in the first coupling position a mechanical coupling between the carrier vehicle and the superstructure is already established (Off: 3/16; 18/7-10), and
wherein in the complete coupling position no relative movement between the carrier vehicle and the superstructure is possible (Off: 3/19; 10/26-29; 18/20-23).

2. Coupling device (1) according to claim 1,
characterised in that
the operating mechanism (30) has a delay section (33) for delaying the start of the movement of the media mechanism (20) from the shut-off position into the supply position until the first coupling position of the coupling mechanism (10) has been reached.

3. Coupling device (1) according to claim 2,
characterised in that
the delay section (33) has a guide geometry (34) with a guide curve (35), wherein a guide element (22) of the media mechanism (20) is mounted moveably within the guide curve (35), wherein a straight-line movement of the guide element (22) is provided for the delay and a height adjustment of the guide element (22) is provided for the movement of the media mechanism (20) into the supply position.

4. Coupling device (1) according to claim 1,
characterised in that
the operating mechanism (30) has at least one actuator, in particular a linear actuator, for an automated movement of the media mechanism (20) and/or the coupling mechanism (10).

5. Coupling device (1) according to claim 1,
characterised in that
the guide means (31) has a gear mechanism for converting a transverse movement of the guide means (31) into a rotary movement of the coupling mechanism (10).

6. Coupling device (1) according to claim 1,
characterised in that
the media mechanism (20) has several plug contacts (21), arranged in pairs, wherein at least one plug contact (21) for a hydraulic coupling (21c) and at least one plug contact (21) for an electrical coupling (21a, 21b), in particular a high-voltage coupling, are arranged on the media mechanism (20) and the plug contacts (21) can in each case make contact with an associated mating plug contact of the carrier vehicle (41) and/or the superstructure (42) in the supply position.

7. Coupling device (1) according to claim 6,
characterised in that
the operating mechanism (30) has at least one cover (36) for the media mechanism (20) which is arranged at a distance from the media mechanism (20) and covers the plug contacts (21) opposite the carrier vehicle (41) and/or the superstructure (42) and is coupled with the operating mechanism (30) and mounted moveably via a lever mechanism (37).

8. Coupling device (1) according to claim 7,
characterised in that
the lever mechanism (37) has a gear mechanism such that the media mechanism (20) is substantially completely covered by the cover (36) in the shut-off position and the media mechanism (20) is uncovered in the supply position.

9. Coupling device (1) according to claim 1,
characterised in that
the media mechanism (20) has a further guide element (23) for tilt-free movement of the media mechanism (20).

10. Agricultural working vehicle (40) comprising a carrier vehicle (41), a superstructure (42) and a coupling device (1) for mechanical coupling and media supply between the carrier vehicle (41) and the superstructure (42),
characterised in that
the coupling device (1) is designed according to claim 1.

11. Method for mechanical coupling and media supply between a carrier vehicle (41) and a superstructure (42) with a coupling device (1), in particular according to claim 1, which has a coupling mechanism (10) for establishing a mechanical coupling between the carrier vehicle (41) and the superstructure (42) and a media mechanism (20) for establishing a media supply between the carrier vehicle (41) and the superstructure (42) which are operatively connected via an operating mechanism (30), wherein the coupling mechanism (10) is mounted so as to be moveable between at least one first coupling position at least partially forming the mechanical coupling and a release position releasing the mechanical coupling, wherein the media mechanism (20) is also mounted so as to be moveable between a supply position forming the media supply and a shut-off position shutting off the media supply, characterised in that a forced guidance of the media mechanism (20) from the shut-off position into the supply position is initiated on a movement of the coupling mechanism (10) from the release position into the first coupling position,
wherein in the first coupling position a mechanical coupling between the carrier vehicle and the superstructure is already established (Off: 3/16; 18/7-10
wherein after reaching the first coupling position the coupling mechanism (10) is further locked and shifted into the complete coupling position (Off: 10/18, 18/13), so that relative movements between superstructure and carrier vehicle are no longer possible (Off: 10/23, 18/22).

12. Method according to claim 11,
characterised in that
the start of the movement of the media mechanism (20) from the shut-off position into the supply position is delayed until the first coupling position of the coupling mechanism (10) has been reached.

13. Method according to claim 11,
characterised in that
when the first coupling position of the coupling mechanism (10) is reached, a cover (36) is removed from the media mechanism.

14. Method according to claim 11,
characterised in that
the forced guidance of the media mechanism (20) from the shut-off position into the supply position and the movement of the coupling mechanism (10) from the release position into the first coupling position is performed reversibly, wherein the media mechanism (20) is shifted into the shut-off position and the coupling mechanism (10) into the release position.
